(19) United States
(12) Patent Application Publication
(10) Pub. No.: US 2017/0066186 A1
(43) Pub. Date: Mar. 9, 2017

(54) METHOD FOR FABRICATING A COMPOSITE CONSTRUCTION ELEMENT

(71) Applicant: LAING O'ROURKE AUSTRALIA PTY LIMITED, North Sydney (AU)

(72) Inventor: James Bruce Gardiner, Chippendale (AU)

(21) Appl. No.: 15/120,590

(22) PCT Filed: Feb. 23, 2015
(86) PCT No.: PCT/AU2015/050067

§ 371 Date: Aug. 22, 2016

(30) Foreign Application Priority Data
Feb. 21, 2014 (AU) 2014900569

(51) Int. Cl. B29C 67/00; B33Y 10/00; B28B 1/00

(52) U.S. Cl. CPC B29C 67/0055; B28B 1/001; B33Y 10/00; B29K 2025/06

(57) ABSTRACT

A method for fabricating a composite construction element, used to construct buildings, bridges or similar structures, using a computer-controlled apparatus. The method involves providing computer instructions derived from a 3D model of a composite construction element to the apparatus, selectively operating the apparatus to fabricate a core from a first building material, selectively applying a settable second building material to the core to form a skin thereon, and at least partially curing the skin to form a shell at least partially enclosing the core, the core and shell thereby forming the composite construction element.

### TECHNICAL FIELD

The present invention relates to fabricating construction elements, being objects used to construct a building, bridge or similar structure. In particular, the invention relates to fabricating a composite construction element having at least two portions having different material properties.

### BACKGROUND TO THE INVENTION

When constructing a building, a common approach to create internal and external walls, as well as floors and roofs, is to install pre-fabricated panels known as Structurally Insulated Panels (SIPs). SIPs are a composite construction element consisting of a foamed material core sandwiched between two substantially rigid, structural planar sheets or boards. These panels are popular as they can allow the efficiency of a building project to be improved, as the large, structural and generally lightweight panels can be installed quickly and easily, they are strong and have high insulation values.

An SIP typically comprises a polymer foam core, such as polystyrene foam or polyurethane foam, joined to two planar sheets formed from a range of materials including plywood, metal or cement.

Whilst SIPs may offer some advantages over other construction techniques, they also suffer from some drawbacks. For example, as SIPs are configured as planar panels, this inherently limits the geometry of structures which can be formed from SIPs.

Conventional SIPs also suffer from the drawback of having foam cores formed from organic foamed materials, which have proven to be highly flammable and present a significant fire risk.

Furthermore, due to the construction of a conventional SIP, a panel will only support less than a specified maximum load in limited orientations.

Accordingly, it would be advantageous to provide a construction element having similar properties as an SIP which has a non-planar or complex geometry, and/or which can support a load exerted thereon from various orientations, or that may be structurally optimised to support particular loads according to functional requirements.

Furthermore, it would be useful to provide a solution that avoids or alleviates any of the disadvantages present in the prior art, or which provides an alternative to prior art approaches.

### SUMMARY OF THE INVENTION

According to one aspect of the invention there is provided a method for fabricating a composite construction element using a computer-controlled apparatus, the method involving the steps of receiving, by the apparatus, computer instructions relating to a core geometry, moving and selectively operating the apparatus to selectively fabricate a core comprised of a first building material, corresponding with the core geometry, selectively applying a settable second building material to at least a portion of the core, thereby forming a skin of settable second building material, and at least partially curing the skin to form a shell at least partially enclosing the core.

According to a further aspect of the invention, the apparatus further comprises a milling spindle and/or a material deposition head in communication with a supply of the first building material, and the selective fabrication of the core involves selectively milling a block of the first building material to remove portions of first building material, or selectively depositing portions of the first building material, in either case, progressively fabricating the core.

According to another aspect of the invention, the selective application of the settable second material involves one or more of dipping the at least a portion of the core in a bath of the settable second material and selectively spraying the at least a portion of the core with the settable second material, to form the skin.

### BRIEF DESCRIPTION OF THE DRAWINGS

Preferred embodiments of the invention will now be described, by way of example only, with reference to the accompanying drawings in which:

FIGS. 1A and 1B show a core of a composite construction element being fabricated with a computer-controlled milling spindle;

FIGS. 2A and 2B show a core of an alternative composite construction element being fabricated with a computer-controlled material deposition apparatus;

FIG. 3A shows a further alternative composite construction element partway through fabrication;

FIG. 3B shows the composite construction element shown in FIG. 3A being fabricated with a computer-controlled milling spindle;

FIGS. 4A and 4B show two assemblies prior and post integration with a composite construction element;

FIGS. 5 and 6 show two different rectilinear composite construction elements;

FIGS. 7A to 7E show stages of fabricating a further alternative composite construction element having integrated services;

FIGS. 8A to 8C are partial section views of two alternative multi-layer composite construction elements;

FIG. 9 is a cross-section of an alternative complex construction element having integrated architectural fittings;

FIGS. 10A to 10F illustrate a preferred, actual and adjusted geometry of an alternative composite construction element; and

FIGS. 11A to 11C are cross-section views of three alternative edge strip components.

### DETAILED DESCRIPTION OF PREFERRED EMBODIMENTS

The following disclosure relates to methods for fabricating composite construction elements. Construction elements are generally any object used to construct part of a building, bridge or similar structure, including smaller structures such as landscape elements, or may form the entire structure. A composite construction element comprises at least two portions having different properties, typically formed from different materials. In particular, the disclosed methods employ computer-controlled apparatus to fabricate a composite construction element responsive to computer instructions derived from a computer model of the composite construction element. In order to fabricate the composite construction element, the apparatus is guided by the computer instructions to fabricate a core from a first building material, by selectively removing and/or applying a first building material, and covering at least a portion of the core with a settable second building material to form a skin. The settable second material is then cured to form a shell. Further processes may be performed to affect the structure and/or appearance of the composite construction element.

Reference will be made throughout this specification to ‘computer instructions’ which at least partly relate to computer instructions derived by a computer application from a three-dimensional (3D) model of the construction element. The 3D model may be created by a user operating modeling software, such as computer aided design (CAD) software, or by a computer algorithm, or by a combination of these two approaches. The instructions specify, amongst other things, the movement of the computer-controlled apparatus and the operation of one or more attachments connected to the apparatus and adapted to fabricate a construction element, such as the milling head.

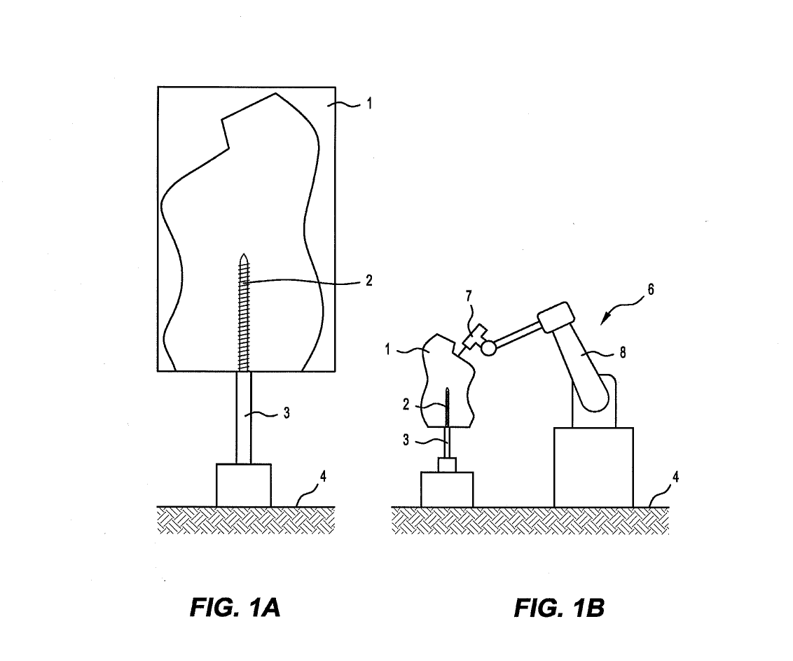

FIGS. 1A-1B show the initial stages of fabricating a composite construction element, where a construction element core 9 is fabricated.

In FIG. 1A, a block 1 of first building material is shown affixed to a locator pin 2 connected to a docking station 3 secured to the ground 4. For illustrative purposes, the block 1 has a notional profile 5 demarcated thereon, indicating a desired construction element core geometry. The locator pin 2 is generally removably connected to the block 1 and removed after fabrication of the core 9. However in some instances the locator pin 2 may be left in place to assist with moving the finished construction element, for example, when installing the element to a structure or removing the element from a structure for maintenance. The core 9 may also have a plurality of locator pins 2 (not shown) or female connectors (not shown), potentially arranged at intervals around a peripheral region, to assist with these purposes.

In FIG. 1B, the assembly shown in FIG. 1A is located adjacent to a computer-controlled apparatus 6. The apparatus 6 has a milling head 7 attached to a movable robotic arm 8. Responsive to computer instructions relating to the desired construction element core geometry, the arm 8 moves the milling head 7 relative to the block of material 1 and selectively operates the milling head 7, thereby removing specific portions of the block 1 to fabricate the core 9, which corresponds with the desired construction element core geometry.

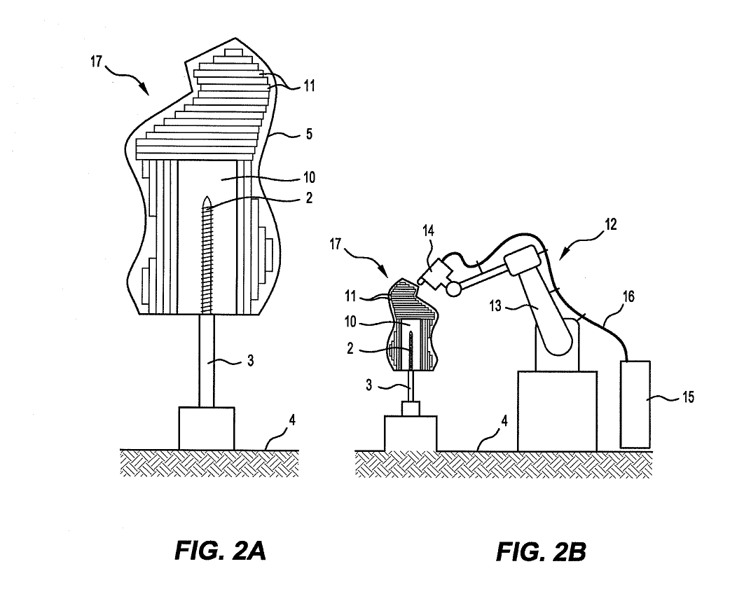

FIGS. 2A-2B show the initial stages of fabricating an alternative composite construction element, where an alternative construction element core 17 is fabricated.

In FIG. 2A an alternative block of material 10 is shown affixed to the floor 4 via the locator pin 2 and docking station 3. At least some of the external surfaces of the block 10 have additional portions of first building material 11 arranged thereon.

In FIG. 2B, the block 10 is located adjacent to an alternative computer-controlled apparatus 12. The apparatus has a material deposition head 14 attached to a movable robotic arm 13. The deposition head is in fluid communication with a supply of substantially liquid first building material, which may be stored in a reservoir 15, via one or more hoses 16. Responsive to computer instructions relating to a desired construction element core geometry, the arm 13 moves the material deposition head 14 relative to the block of material 1 and selectively operates the material deposition head 14, successively depositing portions of the first material 11 in specific locations to fabricate the core 17, which corresponds with the desired construction element core geometry. The portions of first building materials 11 are typically deposited as beads of material, which typically form layers. Each layer may be formed of a single continuous bead, or a plurality of beads. Each layer may also be planar, or non-planar and three-dimensional, for example, having double-curved or faceted portions. It will be appreciated that deposition includes extrusion, jetting or spraying of the first building material.

It will be appreciated that whilst the computer-controlled apparatus 12 is shown in FIG. 2B depositing portions of first building material 11 directly on to the surfaces of the block 10, the apparatus 12 may also deposit first material directly onto the ground 4 or any other substrate to fabricate the core 17. The presence of the block 10 is optional depending on a number of factors such as the availability of depositable first material, the geometry of the core 17, or time available to deposit the first material.

Optionally, the computer-controlled apparatus 12 is adapted to have inter-changeable fabrication heads, allowing the material deposition head 14 to be replaced with a milling head (not shown), such as previously discussed in relation to FIG. 1B. In this scenario, the apparatus 12 may perform a further stage of fabrication and remove specific portions of the deposited first material with the milling head, in order to refine the surface finish of the core 17, such as adding fine decorative or functional features. The steps of selective deposition and selective milling may also be repeated a number of times in order to fabricate specific features in the core 17.

The core 9, 17 preferably defines a plurality of voids, in order to reduce the mass of material required to fabricate the core 9, 17 and the weight of the core 9, 17. This may be achieved by using a foamed material, which comprises a pre-determined quantity of gas bubbles, as the first building material. Such materials are preferably fire retardant, readily available, light weight and provide good sound and/or temperature insulation. An inorganic foamed material is typically suitable for these purposes, such as basalt, or in some instances a combination of inorganic and organic foamed materials would be suitable, thereby allowing a fireproof outer shell of basalt to be formed. Also, for at least the outer surfaces of the core 9, 17, it is preferable to use an open cell foamed material, as this provides a greater mechanical connection with a second building material skin. This is discussed further below.

Optionally, the core 9, 17 is fabricated from a non-regular density first building material, thereby allowing specific portions of the core 9, 17 to be fabricated having different densities. This may be achieved by varying the density of gas bubbles in a foamed first building material during fabrication of the core 9, 17. For example, the block 1 may comprise a laminated block (not shown) having different layers formed from different density foams, and the apparatus 6 fabricate the core 9 from the laminated block, as detailed above in relation to FIGS. 1A-1B. Alternatively, the core 17 may be fabricated by varying the gas content of a foamed first building material during deposition of various layers or beads of first building material by the apparatus 12, as detailed above in relation to FIGS. 2A-2B.

Alternatively, the density of the first building material is varied and non-uniform by selectively adding additional materials to the first building material. For example, this may also involve the material deposition head 14 being in communication with a supply of fibres, or wood flour, which is selectively mixed with the first building material to adjust its density, prior to being deposited and forming part of the core 17. This would allow layers of strata to be formed through the core 17. The ratio of first building material to additional material may be varied significantly. For example, where the first building material is a foam and the additional material is glass fibres, the foam may be present in such a low quantity to simply hold the fibres together, thereby allowing a heavier layer or portion to be fabricated.

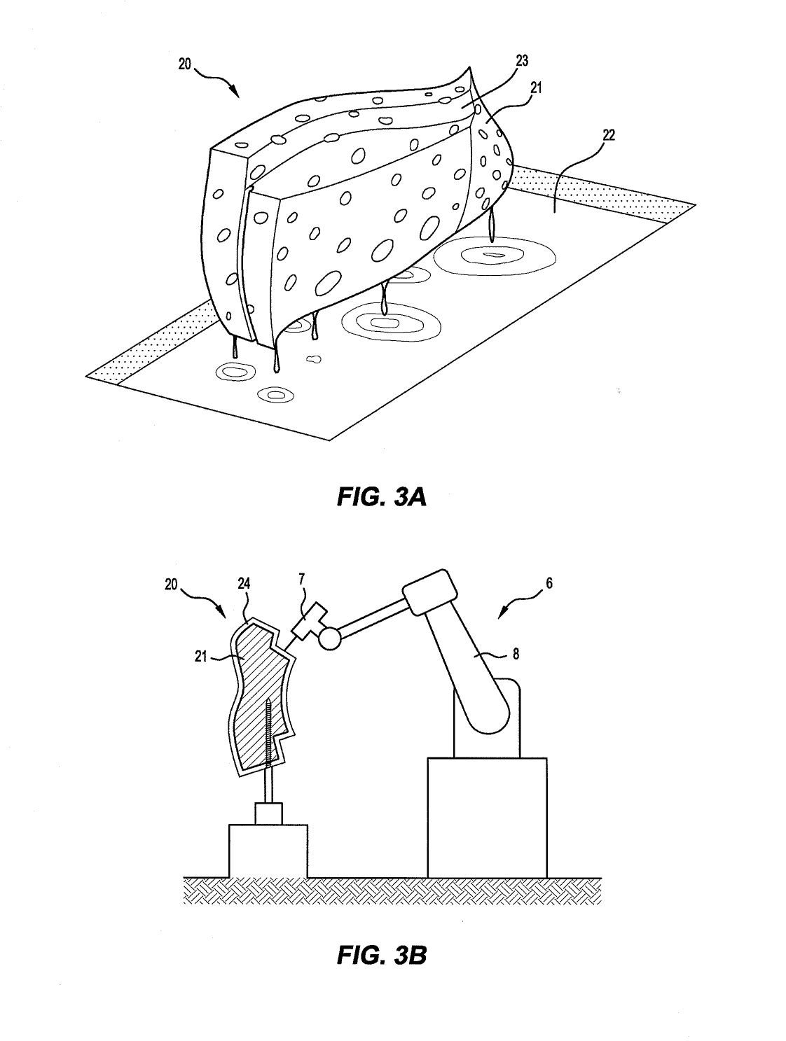

In FIG. 3A, a composite construction element 20 is shown elevated above a bath 22 of substantially liquid, settable second building material. The construction element comprises a core 21 at least partly covered with the settable material, forming a skin 23 thereon. The core 21 has complex (‘freeform’) geometry fabricated by either of the processes described above. The skin 23 has been applied by dipping the core 21 into the bath 23, whereby the settable building material covers and adheres to each submerged portion of the core 21.

The dipping process is performed by a computer-controlled apparatus (not shown) adapted to lift the core 21 by one or more locator pins (not shown) connected to the core 21 and dip the core 21 into the bath of settable building material 22, guided by computer instructions. This may be the apparatus 6, 12 that fabricated the core 21, or a different apparatus. Following being dipped one or more times, the core 21 is drained and the skin 23 cured to form a shell 24 that at least partially encloses the core 21. Optionally, the steps of dipping and curing may also be repeated to form a second shell (not shown) located on a previously uncoated portion of the core, or at least partially enclosing the first shell.

Alternatively, the composite construction element 20 is fabricated by spraying the core 21 with the settable second building material to form the skin 23 (not illustrated). The spraying is typically performed by the apparatus 6, 12 that fabricated the core 21, where the apparatus 6, 12 has a spray-gun attachment (not shown) attached to the robotic arm 8, 13 and in communication with a supply of the settable second building material. Responsive to computer instructions relating to a desired skin 23 geometry, the arm 8 moves the material deposition head 14 relative to the core 21 and selectively sprays the settable building material onto the core 21, successively depositing portions of the settable building material in specific locations to fabricate the skin 23. Once the skin 23 is formed, it is at least partially cured prior to a second skin being applied, or fully cured to form the shell 24. The second skin may comprise a different settable material, thereby forming a plurality of shell layers having different material properties.

The settable second building material is preferably a fine, cementitious composition that flows rapidly around the core 21, filling or coating recesses therein and adhering to the surfaces of the core 21, particularly where an open cell foam has been used as the first building material, and cures rapidly to form a strong, rigid shell 23. This may involve additional curing processes to accelerate the curing of the shell 23, such as exposing the shell 23 to a heated gas and/or liquid, or spraying a chemical setting agent or catalyst onto the shell 23. Optionally, prior to dipping the core 21 in the bath 22, or spraying the core 21 with the settable second material, the core 21 may be selectively sprayed by the apparatus 6, 12 with one or more materials to assist the settable material adhering to the core 21, such as fine fibrous filaments or an adhesive. Further optionally, this may include applying a chemical setting agent or catalyst to the core 21 to accelerate curing of the shell 24. Settable second building material compositions may include one or more of cement, concrete, gypsum, ceramic or geopolymer.

FIG. 3B shows an optional further stage of fabrication in which the construction element 20 is reconnected to the docking station 3 and the milling head 7 of the computer-controlled apparatus 6 removes specific portions of shell from the construction element 20. This may be to refine the external surfaces of the element 20 to fit within tolerances and/or to add decorative or functional features to the shell. For example, specific portions of the element 20 may be milled to ensure the element 20 is able to be assembled onto a larger structure or for other components, such as window or door frames, to be connected to the element 20. Alternatively, signage text or braille details may be milled into specific portions of the element 20.

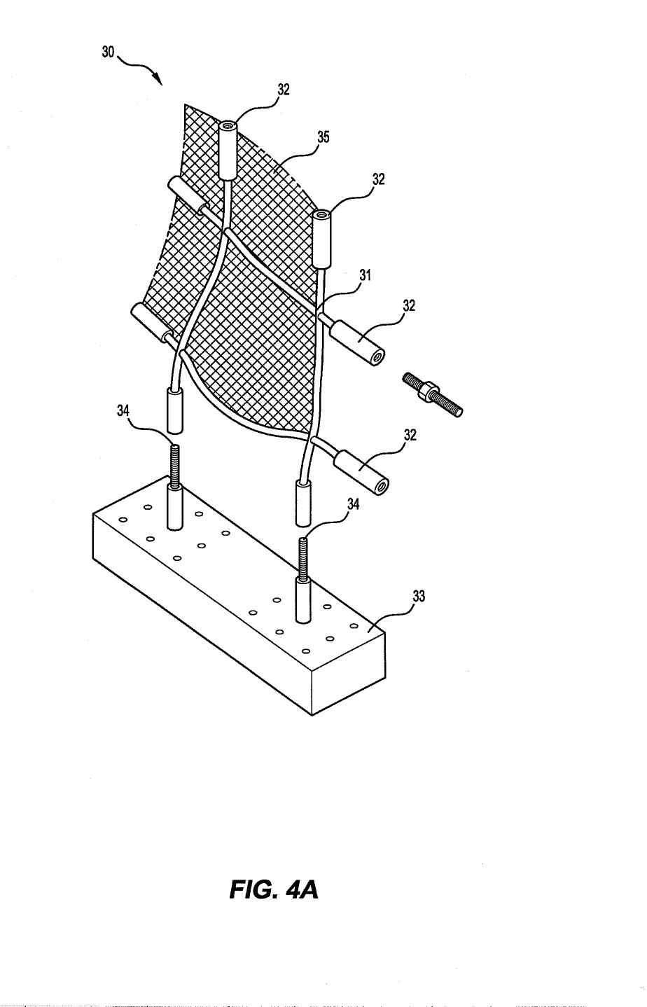

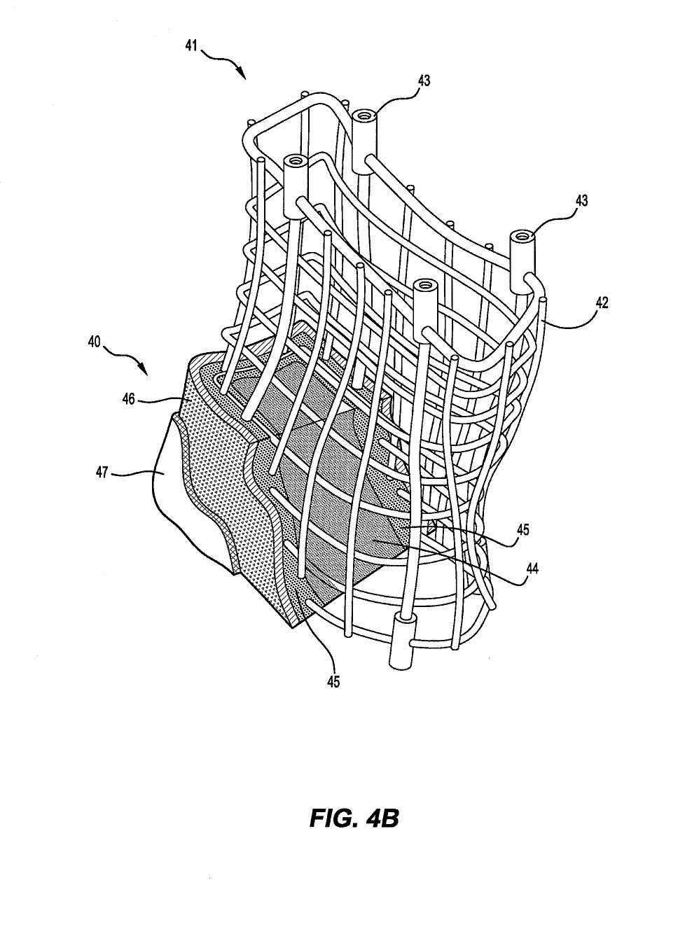

FIG. 4A shows an assembly 30 comprising a reinforcement bar (‘rebar’) frame 31 having a plurality of threaded connectors 32, the frame 31 spaced apart from a base 33 also having threaded connectors 34. The frame 31 has mesh panels 35 attached between at least some of the frame members. The assembly 30 replaces the block 10 in the fabrication process described in relation to FIGS. 2A and 2B, typically being arranged in place, adjacent the apparatus 12, by a gripper attachment (not shown) connected to the apparatus 12, prior to deposition of first building material by the material deposition head 14. The assembly 30 can prove useful in a number of situations as the rebar frame 31 provides structural integrity for a core (not shown) fabricated on or around the frame 31, and the mesh panels 35 provide a surface for first building material to be deposited on and adhered to. The threaded connectors 32, 34 also assist fixing and moving the assembly 30 during the fabrication process, and fixing the finished composite construction element (not shown) to other like elements or a structure to which the element is connected to.

FIG. 4B shows an alternative assembly 41 within a multi-layer composite construction element 40. The composite element 40 is shown in partial section for illustrative purposes. The assembly 41 comprises a rebar frame arranged as a cage 42 and a plurality of threaded connectors 43. The composite construction element 41 has been formed by fabricating an inner core 44 from a low density foam, according to the fabrication process described in relation to FIGS. 1A-1B or FIGS. 2A-2B. The assembly 41 has been arranged around the inner core 44 and dense fibre foam layer 45 fabricated by the material deposition head 14 selectively depositing the fibre filled foam on the inner core 44 and the cage 42. An outer core 46 has then been fabricated by the material deposition head 14 depositing a medium density foam on the fibre foam layer 45. An outer shell 47 has then been fabricated by dipping the assembly 41 and layers 44-46 in a reservoir of the settable second material, or spraying the settable second material on the outer core 46. The settable material is then cured to form a rigid shell 47.

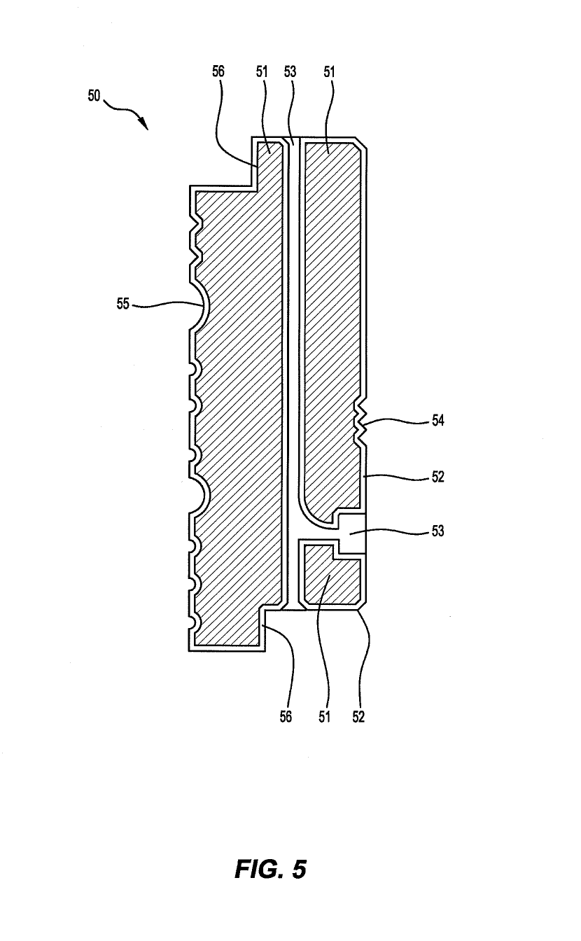

In FIG. 5, a cross-section of a composite construction element 50 is shown, the element 50 configured as a substantially rectilinear wall or ceiling panel. The element 50 is fabricated according to the process steps described above, and has a core 51 formed from a first, lightweight material and a shell 52 arranged around the core 51 formed from a second, rigid material. The core 51 includes a services conduit 53, functional surface finishes 54 and decorative surface finishes 55. The services conduit 53 is adapted to receive conventional service components (not shown), such as power and data cables. The functional finishes 54 may include an acoustic treatment, signage text, braille or other functional textures to improve the shell's resistance to loading or abrasion. The decorative features 55 may include two or three dimensional textures and recesses. The panel 50 also includes a stepped joint 56 to assist placement and fixing of the panel 50 to adjacent panels or other structures. The joint 56 also helps reduce dust and moisture ingress into a structure which the panel 50 is attached to.

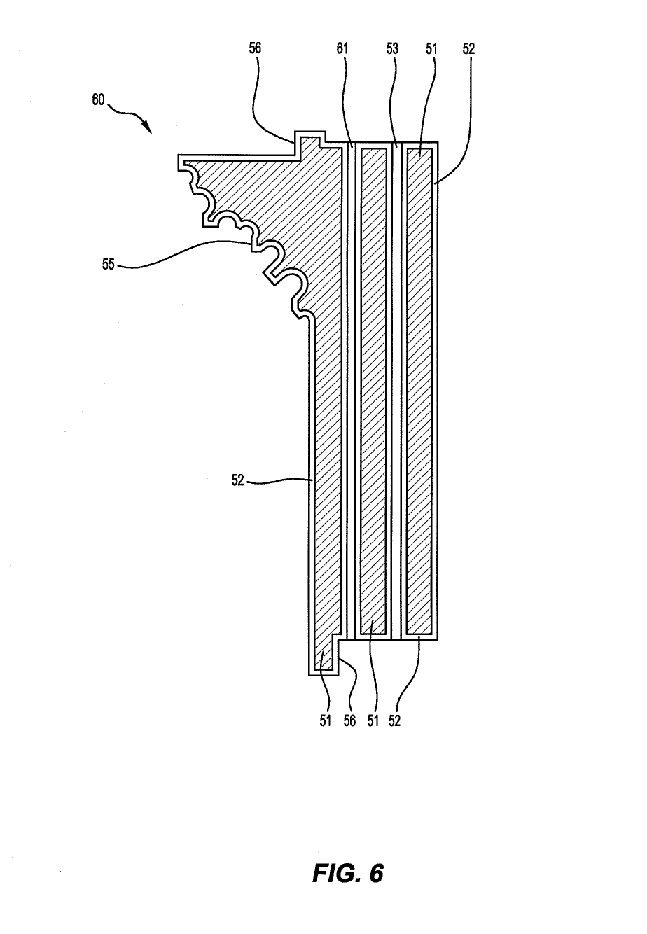

FIG. 6 shows an alternative composite construction element 60, configured as a substantially rectilinear wall or ceiling panel. Construction element 60 comprises many identical features to element 50, whereby corresponding reference numerals indicate corresponding features. The element 60 also includes a post-tension conduit 61 for receiving tensioning means (not shown) to secure the element 60 to an adjacent panel or structure. Tensioning means may include recessed dowels, tensioning cables or fibres, high strength flexible glues and the like. The decorative features 55 of the element are adapted to provide the appearance of period architectural features, such as a particular cornice moulding.

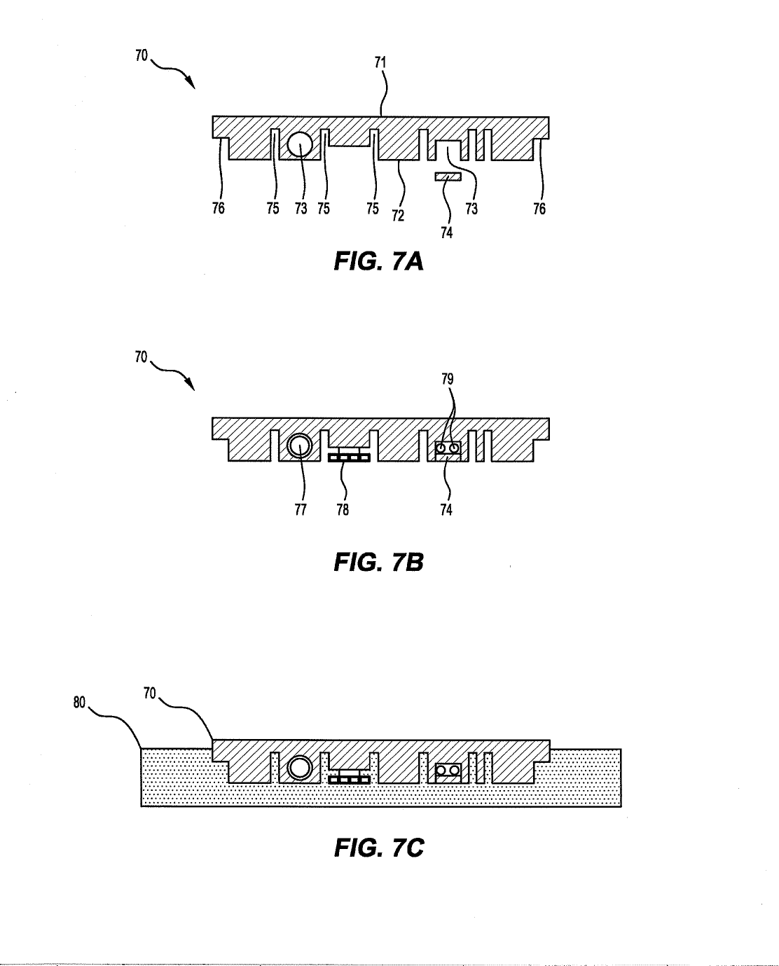

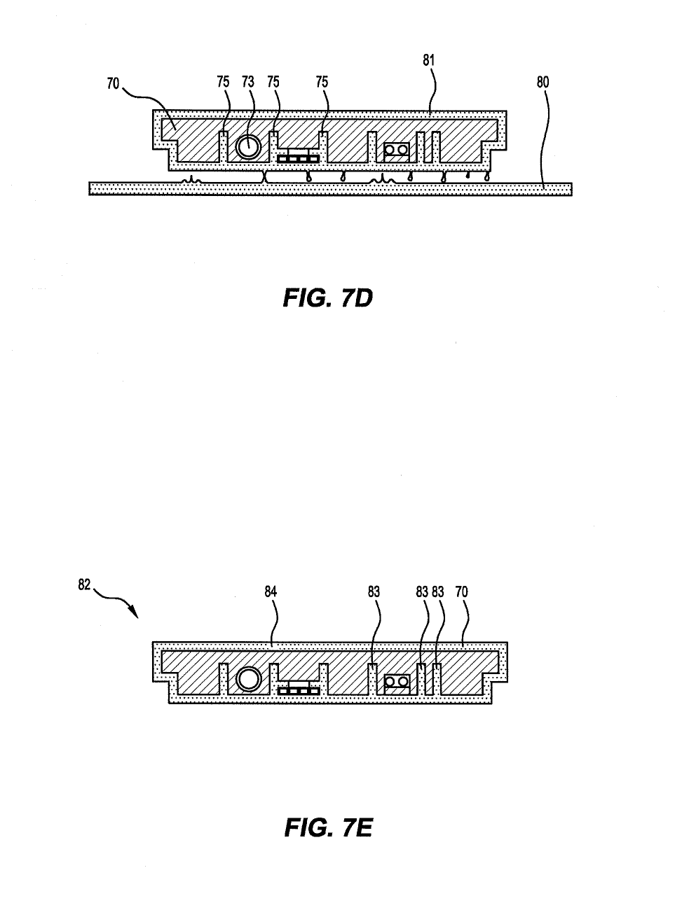

FIGS. 7A-7E illustrate cross-sectional views of the various stages of fabricating a construction element having integrated services.

FIG. 7A shows a core 70, formed from a first building material and fabricated using one or more of the process steps detailed above. The core 70 is configured as a substantially rectilinear panel having planar front 71 and rear 72 surfaces. The rear surface 72 has a plurality of services conduits 73 arranged therein. A separate in-fill panel 74, adapted to seal one of the services conduits, is shown spaced apart from the rear surface 72. The core 70 also has a plurality of rib recesses 75, extending from the rear surface 72 towards the front surface 71. Each rib recess 75 has two opposing walls spaced apart a predetermined distance. The core 70 also has two stepped joints 76 extending at each side, adapted to connect to an adjacent panel or structure.

FIG. 7B shows the core 70 with various services 77-79 inserted into the services conduits 73 and the in-fill panel 74 inserted into a complimentary conduit 73. The services include a waste water pipe 77, cooled water pipes 78 (to create a ‘chilled beam’ feature) and hot and cold water pipes 79. It will be appreciated that these are merely examples of the different services which may be installed into the core and that many other services may also be inserted into the services conduits 73.

FIG. 7C shows the core 70 having integrated services 77-79 during a dipping stage, the core 70 partially submerged in a bath 80 of substantially liquid, settable second building material.

FIG. 7D shows the core 70 after being completely submerged in the bath 80 and lifted above the bath 80 to drain excess second building material. A layer of second building material 81 has adhered to the core 70 and filled each exposed rib recess 75 and services conduit 73.

FIG. 7E shows a finished composite construction element 82, after the layer of second building material has hardened to form a solid, monocoque shell 84 that encloses the core 70. The hardened shell 84 seals each of the services it is in contact with, providing a high level of fire protection and insulation to the sealed services. The shell 84 also extends within each of the rib recesses 73, where, once solidified, the shell 84 forms structural ribs 83, increasing the strength and stiffness of the element 82.

Optionally, it is preferable that the width of each rib recess 75 is less than double the width of the shell, to ensure that the hardened shell material entirely fills each rib recess 75. Alternatively, the width of each rib recess 75 is more than double the width of the shell, to ensure that an air gap between each side of each rib recess 75 is maintained.

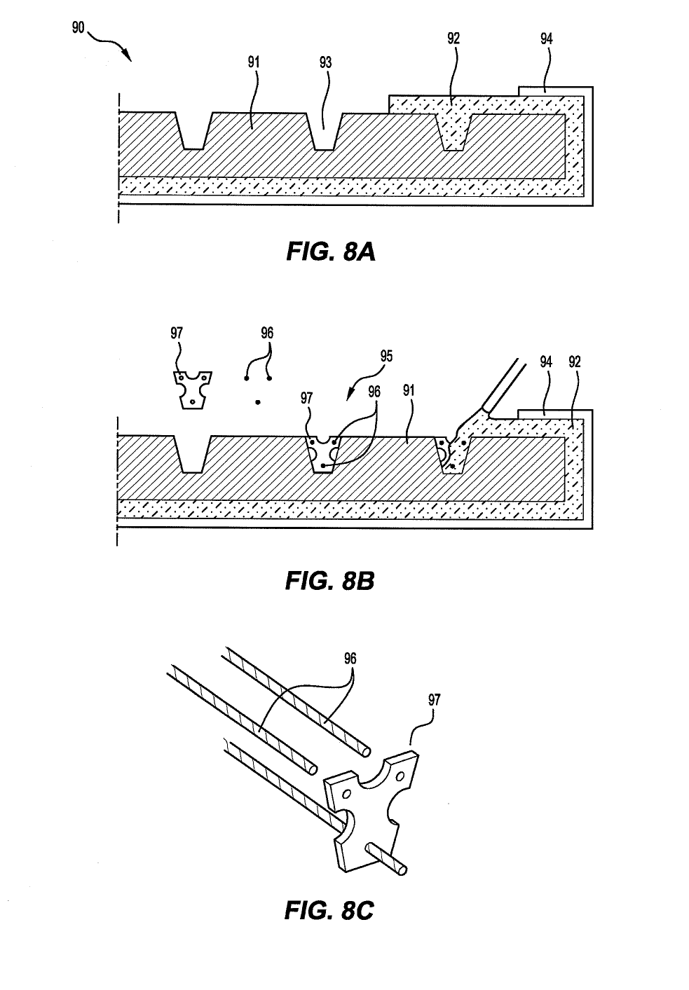

FIG. 8A shows an alternative multi-layer composite construction element 90 in partial section view for illustrative purposes. The construction element 90 comprises an inner core 91, formed from a low density foam, and an outer core 92, formed from a fibre reinforced material, such as a fibre-filled foam, fibre-filled cement or glass reinforced concrete (GRC). The core 91 includes a plurality of tapered rib recesses 93 which the outer core 92 fills. The outer core is at least partially encased in a shell 94 to provide a smooth outer surface. The construction element 91 is fabricated using the fabrication processes described above. In particular, the outer core 92 is fabricated by the apparatus 12 either selectively depositing or spraying the fibre reinforced material onto the core 91, ensuring that the rib recesses 93 are filled with the fibre reinforced material, thereby providing structural enhancement to the construction element 90.

FIG. 8B shows a further alternative multi-layer composite construction element 95, in partial section view, having many identical features to construction element 90, where corresponding reference numeral indicating corresponding features. Construction element 95 includes a plurality of reinforcement bars 96 inserted into each rib recess 93 and held apart by spacing plates 97. The outer core 92 fills each rib recess 93 thereby joining the reinforcement bars 96 to the core 91.

FIG. 8C is a detailed perspective view of the reinforcement bars 96 and one of the spacing plates 97.

In FIG. 9, a cross-section view of an alternative composite construction element 100 is shown having ‘freeform’, complex geometry and architectural fittings attached thereto, being a glazing channel 101 and window 102. The element 100 includes a core 103, formed from a first, lightweight building material, fabricated according to one of the techniques detailed above. The core 103 includes surfaces that are curved in all three dimensions, including undercut features, and a network of conduits 104 extending therethrough. The core 103 has been dipped in a settable second building material, to form an external skin of the settable building material. The skin has then cured to form a rigid shell 105 that encloses the core 103 and fills each conduit 104, thereby forming a respective network of structural braces.

The geometry of the conduits 104 has been arranged to ensure that the structural braces are located appropriately to support a load the element 100 will be subjected to. The arrangement of the conduits 104 may be performed manually, for example, when a user is creating the 3D model of the construction element 100, or may be due to a computer application executing an algorithm, responsive to a data relating to loads the element 100 will be subjected to, to calculate an optimised conduit layout. The conduits 104 may also be arranged to assist the settable second building material to flow through each conduit 104 during a dipping process, minimising the time required to fill each conduit 104 with material and/or expel air from each conduit 104.

The dimensions of the structural conduits 104 may be determined responsive to the shell 105 thickness. For example, the width of each conduit 104 may be specified to not exceed double the thickness of the shell 105, to ensure that each conduit 104 is entirely filled by the solidified shell 105.

Optionally, the shell 105 may be processed post-curing by the apparatus 6, by selectively removing portions of the shell 105. This may be to refine the shell 105 surfaces to allow the architectural fittings 101, 102 to be accurately connected to the construction element 100.

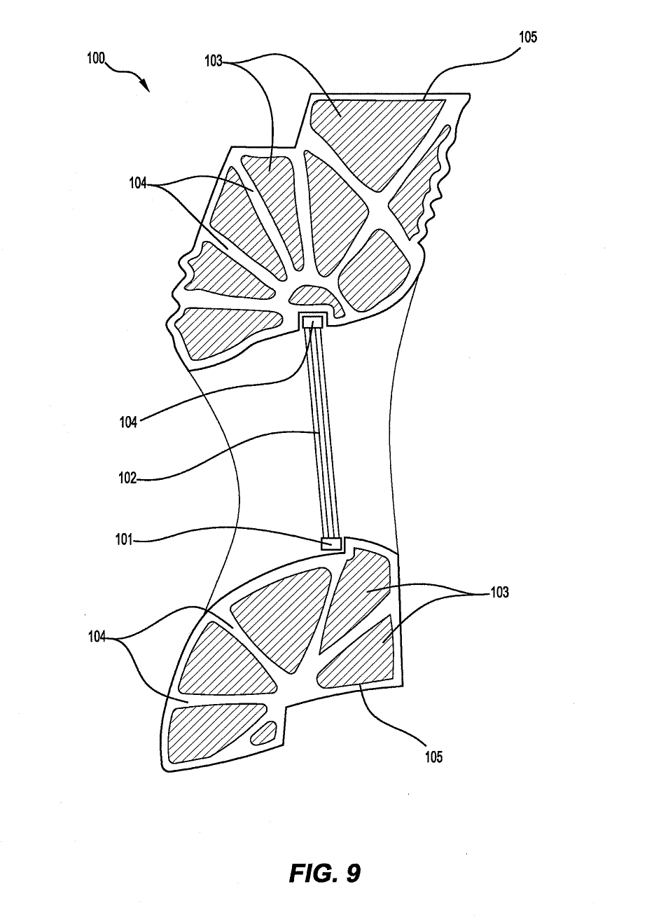

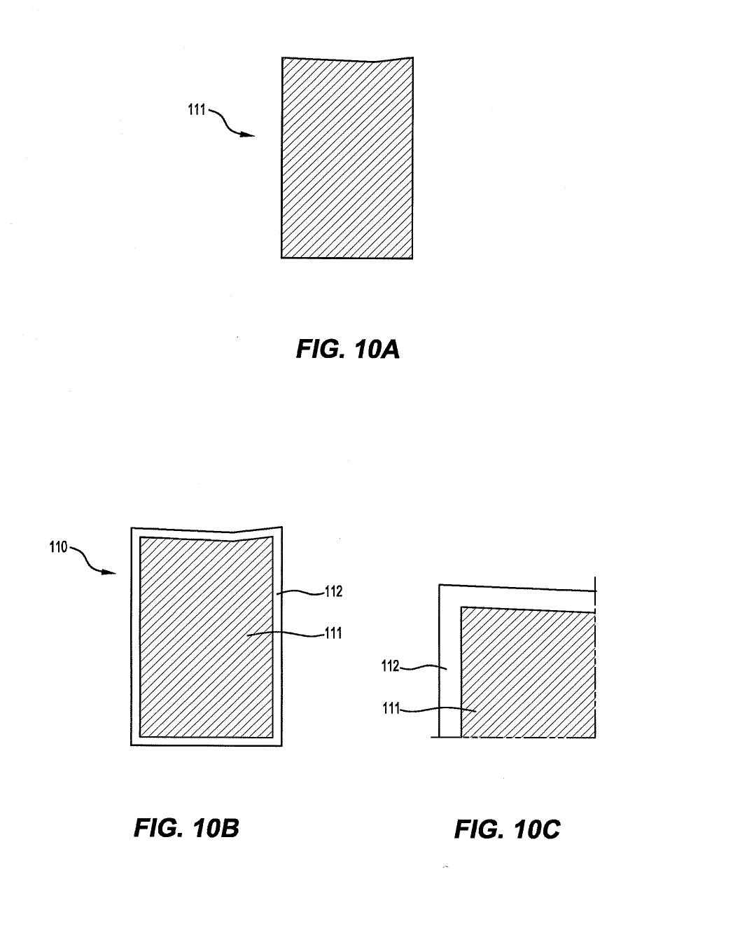

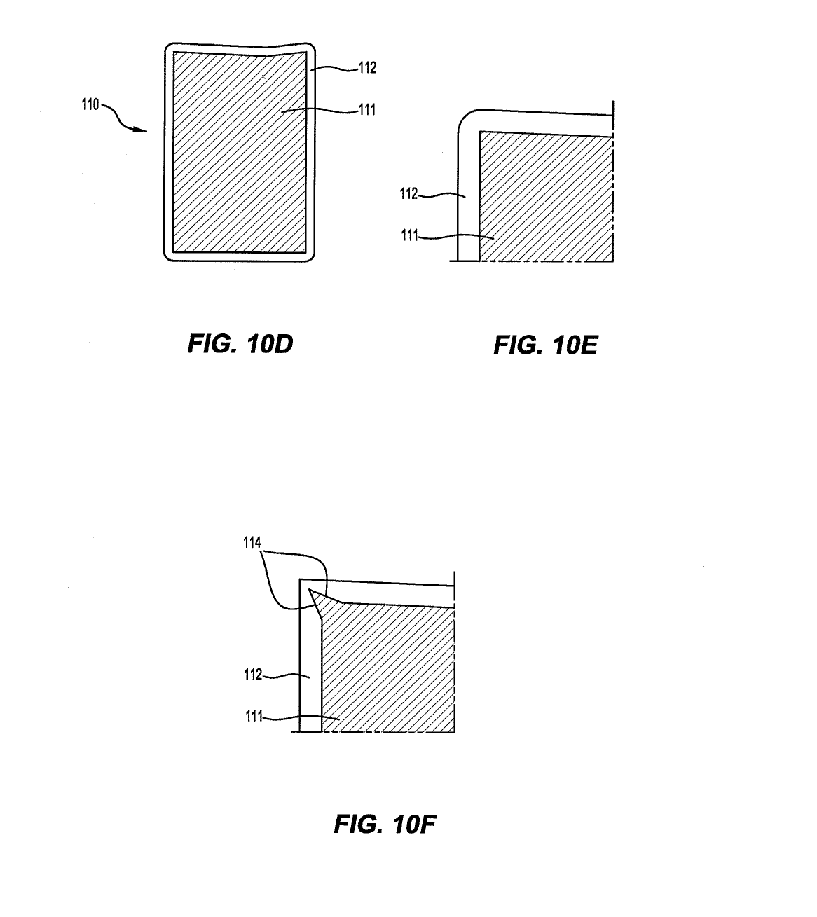

FIGS. 10A-10F illustrate various scenarios relating to corner and/or edge finishes, when fabricating a further alternative composite construction element 110.

FIG. 10A shows a core 111 of the construction element 110, produced by one or more of the fabrication processes described above.

In FIGS. 10B-10C, a cross-section and detailed cross-section view of the desired construction element 110 geometry are shown, the element 110 comprising the core 111 and a shell 112. The element 110 is a configured as a rectilinear panel, having substantially planar surfaces and sharp corners and edges. The shell 112 is fabricated according to a dipping or spraying process, as described above.

In FIGS. 10D-10E, a cross-section and detailed cross-section view of the construction element 110 are shown, illustrating the actual geometry of the shell 112 after application to the core 111. Due to the surface tension of the second building material that forms the shell 112 being unable to support the creation of sharply defined corners and edges, the corners and edges of the shell 112 are rounded.

In FIG. 10F, a detailed cross-section view of the construction element 110 is shown, the element comprising an alternative core 113. To attempt to address the rounding of the edges of the shell 112, the alternative core 113 has an optimised edge geometry, comprising two ramped portions 114 that are inclined away from the surface each ramp 114 is joined to, and join each other at a point. The ramped portions 114 are arranged to retaining settable building material in place, along each desired sharp edge, during curing, to allow the shell 112 to form sharp corners and edges.

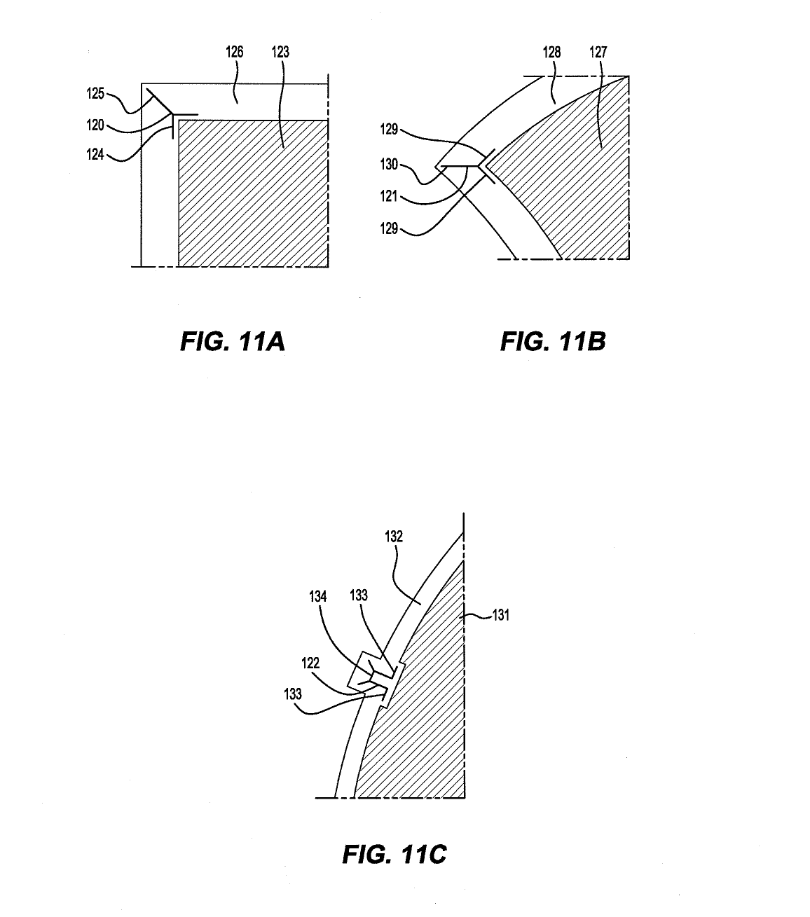

FIGS. 11A-11C are cross section views of various edge strips 120-122 for connecting to an edge of a core, prior to the settable material being applied and cured. Similar to the geometry of the core 113 described above, the edge strips 120-122 help control the surface tension rounding of edges, and assist a shell to form a sharp edge.

FIG. 11A shows a right-angled edge strip 120 connected to a core 123 and surrounded by a shell 126. The right-angled edge strip 120 comprises two core engaging arms 124 secured to respective surfaces of the core 123 either side of an edge, and a barrier arm 125 joined to the engaging arms 124 and extending away from the edge, typically at 45° to each surface the engaging arms 124 are secured to.

FIG. 11B shows a custom angle edge strip 121 connected to an alternative, non-regular shaped core 127 and surrounded by a shell 128. The custom angle edge strip 121 comprises two core engaging arms 129 secured to respective surfaces of the core 127 either side of an edge, and a barrier arm 130 joined to the engaging arms 129 and extending away from the edge. As custom angle edge strip 121 may need to follow three-dimensional curves along the edge, it is typically 3D printed, to allow for efficient customisation.

FIG. 11C shows an insert edge strip 122 connected in a recess in a further alternative core 131 and surrounded by a shell 132. The insert edge strip 123 comprises two recess engaging arms 133 secured to inside surfaces of the recess, and a barrier structure 134 connected to the engaging arms 133 and extending away from the recess.

It will be apparent that obvious variations or modifications may be made to the present invention which are in accordance with the spirit of the invention and intended to be part of the invention. Although the invention is described above with reference to specific embodiments, it will be appreciated that it is not limited to those embodiments and may be embodied in other forms.

1-24. (canceled)

25. A method for fabricating a composite construction element using a computer-controlled additive manufacturing apparatus configured to fabricate a first building material, the method involving the steps of:
receiving, by the apparatus, computer instructions relating to a core geometry;
moving and selectively operating the apparatus to selectively fabricate a core comprised of the first building material in one or more specific locations, corresponding with the core geometry;
moving the core to dip at least a portion thereof in a settable second building material contained in a reservoir, thereby forming a skin of settable second building material thereon; and
at least partially curing the skin to form a shell at least partially enclosing the core, thereby forming the composite construction element.

26. The method for fabricating a composite construction element according to claim 25, wherein the core has at least one aperture extending at least partially therethrough, the method further comprising the steps of:
dipping the core and forming the skin of settable second building material thereon to substantially coat the at least one aperture; and
at least partially curing the skin to form a shell at least partially extending along the aperture.

27. The method for fabricating a composite construction element according to claim 25, further comprising the steps of:
securing a support structure proximal to the apparatus, the support structure dimensioned to be smaller than the core geometry and adapted to adhere to and support the first building material; and
moving the support structure relative to the apparatus such that during the fabrication step, at least some of the first building material adheres to the support structure.

28. The method for fabricating a composite construction element according to claim 27 wherein, the support structure further comprises one or more fixtures arranged at one side thereof adapted to releasably connect with one or more complementary connectors; and
the steps of moving the support structure and the core to dip the at least a portion of the core in the second building material, and the steps of moving at least one of the support structure and the apparatus relative to each other, further comprise the step of connecting each of the at least one complementary connectors to the fixture and then moving the fixture thereby causing complementary movement of the support structure.

29. The method for fabricating a composite construction element according to claim 28, wherein the fixtures are arranged in at least first and second orientations; and
in the step of moving the support structure and the core to dip the at least a portion of the core in the second building material, one of the connectors is connected to one of the fixtures of the second orientation; and
in the step of moving at least one of the support structure and the apparatus relative to each other, one of the connectors is connected to one of the fixtures arranged in the second orientation is connected to one of the connectors.

30. The method for fabricating a composite construction element according to claim 27, wherein the support structure comprises a plurality of openings dimensioned to receive and adhere to the first building material, the openings further comprising one or more of a mesh portion or a foamed material; and
the step of selectively operating the apparatus to fabricate the first building material further comprises fabricating the first building material against at least some of the openings, thereby adhering the first building material to the support structure.

31. The method for fabricating a composite construction element according to claim 27, wherein the support structure further comprises a framework comprising a plurality of bars joined together, and wherein the step of selectively operating the apparatus to fabricate the first building material further comprises fabricating the first building material on the framework.

32. The method for fabricating a composite construction element according claim 27, wherein
the step of securing the support structure further comprises the step of securing a first portion of the support structure proximal to the apparatus; and
the step of selectively operating the apparatus to fabricate the core further comprises the step of adhering at least some of the first building material to the support structure; and
the method further comprising the steps of securing a second portion of the support structure to the first portion of the support structure, and moving at least one of the first and second portions of the support structure and the apparatus relative to each other; and selectively operating the apparatus to fabricate the first building material in one or more specific locations corresponding with the core geometry; and
wherein at least some of the first building material adheres to the second portion of the support structure, thereby progressively fabricating the core.

33. The method for fabricating a composite construction element according to claim 25, wherein the apparatus further comprises a material deposition head configured to selectively expel the first building material therefrom and in communication with a supply of the first building material, and being movable responsive to the computer instructions, and wherein the step of selectively operating the apparatus to fabricate the first building material further comprises selectively operating the material deposition head to selectively deposit portions of the first building material, thereby progressively fabricating the core.

34. The method for fabricating a composite construction element according to claim 33, wherein the step of moving at least one of the support structure and the apparatus relative to each other and selectively operating the apparatus, further comprises moving at least one of the support structure and apparatus relative to each other to allow the apparatus to fabricate a plurality of beads of the first building material, wherein a first bead is arranged extending in a first orientation and a second bead is arranged extending in a second orientation different to the first orientation.

35. The method for fabricating a composite construction element according to claim 33, comprising the further step of prior to selectively depositing the portions of the first building material, selectively adjusting a density of the first building material, thereby adjusting the density of at least some of the portions.

36. The method for fabricating a composite construction element according to claim 35, wherein the apparatus further comprises one or more of a connection to a supply of gas or fibres, and wherein the step of selectively adjusting a density of the first building material further respectively comprises selectively mixing the fibres or the gas with the first building material in a variable ratio.

37. The method for fabricating a composite construction element according to claim 35, wherein the apparatus further comprises the material deposition head being in communication with a supply of a third building material, and the method comprises the further step of after selectively operating the material deposition head to deposit the first building material, selectively operating the material deposition head to deposit one or more portions of the third building material onto the core.

38. The method for fabricating a composite construction element according to claim 37, wherein the step of selectively depositing the one or more portions of the third building material further comprises fabricating the one or more portions of the third building material to form a layer at least partially enclosing the core.

39. The method for fabricating a composite construction element according to claim 25, comprising the further steps of selectively applying a settable fourth building material to at least a portion of the shell to form a second skin of settable fourth building material, and at least partially curing the second skin to form a second shell.

40. The method for fabricating a composite construction element according to claim 26, wherein prior to the step of dipping the at least one aperture in the settable second material, the method comprises the further step of arranging an object in the at least one aperture, thereby allowing the skin to coat the object.

41. The method for fabricating a composite construction element according to claim 26, wherein the step of selectively operating the apparatus to fabricate the at least one aperture further comprises fabricating the aperture extending only partially through the core, thereby forming a rib recess.

42. The method for fabricating a composite construction element according to claim 41, further comprising the step of prior to dipping the at least one rib recess in the settable second building material, arranging a reinforcement structure in the at least one rib recess.

43. The method for fabricating a composite construction element according to claim 25, wherein the apparatus further comprises material removal means for selectively removing portions of the composite construction element, and wherein after at least one of the steps of selectively operating the apparatus to fabricate the core, and at least partially curing the skin to form the shell, the method comprises the further step of selectively operating the material removal means to selectively remove one or more portions of the composite construction element.

44. The method for fabricating a composite construction element according to claim 43, wherein the material removal means comprises a milling spindle, and wherein the step of operating the material removal means further comprises operating the milling spindle in specific locations to remove the one or more portions of the composite construction element.

45. The method for fabricating a composite construction element according to claim 25, wherein the step of selectively operating the apparatus to fabricate the core further comprises fabricating the core having two adjacent surfaces forming an edge, and wherein adjacent the edge, each of the adjacent surfaces have a ramped portion inclined away from the respective surface.

46. The method for fabricating a composite construction element according to claim 25, further comprising the step prior to dipping at least a portion of the core in the settable second building material, of affixing one or more edge strips to an edge of the core, each edge strip having two opposed surface engaging arms for engaging a surface arranged either side of the edge, and a barrier arm connected to, and extending away from, the surface engaging arms.

47. The method for fabricating a composite construction element according to claim 25, wherein the first building material is foam and the second building material is cementitious.
